(19) United States
(12) Patent Application Publication
(10) Pub. No.: US 2024/0083576 A1
(43) Pub. Date: Mar. 14, 2024

(54) AERIAL SYSTEM INCLUDING A THRUSTED PLATFORM AND THRUSTED PLATFORM FOR SAID AERIAL SYSTEM

(71) Applicant: 9399-5702 QUÉBEC INC., Sherbrooke (CA)

(72) Inventors: Hughes Lavigne, Sherbrooke (CA); Guillaume Charron, Sherbrooke (CA); Alexis Lussier Desbiens, Sherbrooke (CA); Julien Rachiele Tremblay, Sherbrooke (CA); Jérémi Barrette, Sherbrooke (CA)

(73) Assignee: 9399-5702 QUÉBEC INC., Sherbrooke, QC (CA)

(21) Appl. No.: 17/931,426

(22) Filed: Sep. 12, 2022

(51) Int. Cl. B64C 39/02

(52) U.S. Cl. CPC B64C 39/024; B64C 2201/126; B64C 2201/128

(57) ABSTRACT

An aerial system including an anchoring member; a support cable extending along a vertical axis and suspended from the anchoring member, a thrusted platform and an end effector. The thrusted platform is suspended from an anchoring member using the support cable and comprises: a frame and at least three bidirectional thrusters for controlling the platform along three degrees of freedom. The at least three bidirectional thrusters are positioned and oriented to produce the thrust force in a substantially horizontal direction along a common substantially horizontal plane, to allow a translation along the common substantially horizontal plane and a rotation around the vertical axis. The system also comprises an end effector mounted to the frame. A thrusted platform suspendable from an anchoring member using a support cable is also provided.

### TECHNICAL FIELD OF THE INVENTION

The present invention relates to the field of aerial system. More particularly, the invention relates to aerial systems including a thrusted platform and to a thrusted platform for a corresponding aerial system allowing the execution of aerial tasks including sampling, repair, maintenance, inspection or the like.

### BACKGROUND

Manual access techniques such as rappelling down a vertical surface, building scaffolding assemblies, using an elevated platform or climbing the vertical surface from below are well known in the art to perform sampling of items located on the vertical surface, inspection of sections of the vertical surface, repairs, maintenance, or the like. Such techniques are however deficient as they are time consuming, involve inherent risks for the user performing the work and greatly limit the accessible locations.

In recent years, Unmanned Aerial Vehicles (UAV) have been used to try and alleviate the issues of manual access techniques and interact directly with their environment using end effectors mounted thereon and specially designed for applications like infrastructure inspection, package delivery, power line inspection, or the like. UAVs including end effectors have also been used to collect samples from the topmost part of tree canopy.

When dealing with vertical walls or structures, the use of UAVs with end effectors mounted thereon to perform inspection, repair, maintenance or sampling tasks however presents several technical challenges, thereby limiting the use of UAVs to perform such tasks. For example, and without being limitative, Global Navigation Satellite System (GNSS) coverage is often of lower quality near large natural obstacles such as cliffs, which can affect the stabilization of a UAV; vertical walls create wind turbulence and gusts from varying directions which act as external perturbations for an aerial system and affect the stability of the system; the aerial sampling or inspection involving a vertical structure entails significant collision risks for the UAV, stabilization of a UAV entails control of several directions, orientation thereof (roll, pitch, rotation), inflight control of the UAV while managing interaction forces caused by interactions with the environment adds a level of complexity, etc.

A possible known solution is to install an end effector onto a platform suspended from the UAV. In an embodiment, the platform can be non-actuated to simply allow the UAV to remain away from obstacles within the environment, with a single downward force aligned with the suspended payload being applied on the UAV. Such a non-actuated platform however provides minimum precision and does not allow interaction of the platform with a vertical surface, an overhanging surface, or the like. Indeed, the non-actuated platform behaves like a pendulum, with horizontal movements of the UAV creating an oscillating motion and the platform tending to rotate, which complicates precise manipulations on small targets on the vertical wall.

In view of the above, it is known to install the end effector on an actuated platform under a UAV. Such systems offer safety advantages when compared to end effectors directly mounted onto a UAV, especially for performing tasks requiring contact with a vertical wall and increased precision of the platform. However, known actuated platforms tend to suffer from several drawbacks limiting the possible uses thereof. For example and without being limitative, known actuated platforms are commonly stabilized at their natural point of equilibrium directly below the UAV with weak actuators. They typically only provide a vertical reach to the end effector, therefore limiting the workspace of the end effector. Other known platforms include thrusters positioned and/or configured to move the platform in different directions, but do not offer a prime thruster positioning and/or orientation to allow optimized movements of the platform for performing aerial sampling, repair, maintenance, inspection or the like using an end effector thereof.

In view of the above, there is a need for an improved aerial system including a thrusted platform and a thrusted platform for same which, by virtue of its design and components, would be able to overcome or at least minimize some of the above-discussed prior art concerns.

### SUMMARY OF THE INVENTION

According to a first general aspect, there is provided an aerial system. The aerial system comprises an anchoring member; a support cable attached to the anchoring member and suspended therefrom, the support cable extending along a vertical axis, and a thrusted platform suspended from the anchoring member using the support cable. The thrusted platform comprises: a frame and at least three bidirectional thrusters each producing a thrust force in a bidirectional direction and allowing the thrusted platform to be controlled thereby along three degrees of freedom. The at least three bidirectional thrusters are positioned and oriented to produce the thrust force in a substantially horizontal direction along a common substantially horizontal plane, with the produced thrust force allowing a translation of the thrusted platform along the common substantially horizontal plane and a rotation of the thrusted platform around the vertical axis. The aerial system also comprises an end effector mounted to the frame and positioned to interact with the environment or acquire data of the environment, through the positioning of the thrusted platform along the substantially horizontal plane.

In an embodiment, the at least three bidirectional thrusters of the thrusted platform are positioned and oriented to produce the thrust force in a direction deviating of a maximum of 20 degrees from a horizontal plane, along the common substantially horizontal plane.

In an embodiment, the at least three bidirectional thrusters of the thrusted platform are positioned and oriented for the thrust force of at least two perpendicular bidirectional thrusters to be of a maximum of 20 degrees from a perpendicular orientation along the common substantially horizontal plane.

In an embodiment, the at least three bidirectional thrusters of the thrusted platform include at least four bidirectional thrusters, with the at least four perpendicular bidirectional thrusters including at least two first bidirectional thrusters producing a thrust substantially perpendicular along the common substantially horizontal plane to the thrust force of at least two second bidirectional thrusters.

In an embodiment, the at least two first bidirectional thrusters of the thrusted platform are positioned between the at least two second bidirectional thrusters along an axis of the common substantially horizontal plane.

In an embodiment, the frame of the thrusted platform includes a central longitudinal shaft extending substantially horizontally along a longitudinal axis X of the common substantially horizontal plane, with the end effector being positioned at a forward end of the central longitudinal shaft. The at least two first bidirectional thrusters produce a thrust force substantially along the longitudinal axis X of the common substantially horizontal plane and are positioned on opposed sides of a center of mass of the thrusted platform.

In an embodiment, the frame of the thrusted platform further includes at least two transversal shafts extending substantially horizontally along a transversal axis Y of the common substantially horizontal plane. The support cable includes a first cable section extending along the vertical axis and at least three second cable sections arranged in a pyramidal configuration and each connected at a proximal end to an end of the first cable section and at a distal end to anchoring points on the thrusted platform being horizontally spaced apart from one another along the common substantially horizontal plane and being positioned along one of the central longitudinal shaft and the transversal shafts.

In an embodiment, the frame of the thrusted platform includes a plurality of frame members together defining a bipolygonal shaped frame, with the common substantially horizontal plane along which the at least three bidirectional thrusters produce the thrust force allowing the translation of the thrusted platform along the common substantially horizontal plane and the rotation of the thrusted platform around the vertical axis extending substantially along the base of the bipolygonal shaped frame defined in the mirror plane connecting the two polygons defining the bipolygonal shape.

In an embodiment, each bidirectional thruster includes a set of antagonist thrusters.

In an embodiment, the aerial system further comprises a winch system operative to vary the length of the support cable and control the vertical positioning of the thrusted platform.

In accordance with another general aspect, there is provided a thrusted platform suspendable from an anchoring member using a support cable. The thrusted platform comprises: a frame; at least three bidirectional thrusters each producing a thrust force in a bidirectional direction and allowing the thrusted platform to be controlled thereby along three degrees of freedom. The at least three bidirectional thrusters are positioned and oriented to produce the thrust force in a substantially horizontal direction along a common substantially horizontal plane, with the thrust force of at least two of the at least three bidirectional thrusters being produced at an angle from one another along the common substantially horizontal plane and allowing a torque around a vertical axis corresponding to a center of mass of the thrusted platform. The thrusted platform also comprises an end effector mounted to the frame and positioned to interact with the environment or acquire data of the environment, through the positioning of the thrusted platform along the substantially horizontal plane.

In an embodiment, the at least three bidirectional thrusters are positioned and oriented to produce the thrust force in a direction deviating of a maximum of 20 degrees from a horizontal plane, along the common substantially horizontal plane.

In an embodiment, the at least three bidirectional thrusters are positioned and oriented for the thrust force of at least two perpendicular bidirectional thrusters to be of a maximum of 20 degrees from a perpendicular orientation along the common substantially horizontal plane.

In an embodiment, the at least three bidirectional thrusters include at least four bidirectional thrusters, with the at least four perpendicular bidirectional thrusters including at least two first bidirectional thrusters producing a thrust substantially perpendicular along the common substantially horizontal plane to the thrust force of at least two second bidirectional thrusters.

In an embodiment, the at least two first bidirectional thrusters are positioned between the at least two second bidirectional thrusters, along an axis of the common substantially horizontal plane.

In an embodiment, the frame includes a central longitudinal shaft extending substantially horizontally along a longitudinal axis X of the common substantially horizontal plane, with the end effector being positioned at a forward end of the central longitudinal shaft. The at least two first bidirectional thrusters produce a thrust force substantially along the longitudinal axis X of the common substantially horizontal plane and are positioned on opposed sides of a center of mass of the thrusted platform.

In an embodiment, the thrusted platform is suspended from a support cable and the frame of the thrusted platform further includes at least two transversal shafts extending substantially horizontally along a transversal axis Y of the common substantially horizontal plane. The support cable includes a first cable section and at least three second cable sections arranged in a pyramidal configuration and each connected at a proximal end to an end of the first cable section and at a distal end to anchoring points on the thrusted platform being horizontally spaced apart from one another along the common substantially horizontal plane and being positioned along one of the central longitudinal shaft and the transversal shafts.

In an embodiment, the frame includes a plurality of frame members together defining a bipolygonal shaped frame, with the common substantially horizontal plane along which the at least three bidirectional thrusters produce the thrust force extending substantially along the base of the bipolygonal shaped frame defined in the mirror plane connecting the two polygons defining the bipolygonal shape.

In an embodiment, each bidirectional thruster includes a set of antagonist thrusters.

In an embodiment, the thrusted platform further comprises a winch system operative to vary the length of the support cable and control the vertical positioning of the thrusted platform.

### BRIEF DESCRIPTION OF THE DRAWINGS

Other objects, advantages and features will become more apparent upon reading the following non-restrictive description of embodiments thereof, given for the purpose of exemplification only, with reference to the accompanying drawings in which:

FIG. 1 is a perspective view of the aerial system including a thrusted platform suspended from an unmanned aerial vehicle (UAV), in accordance with a first embodiment in which the thrusted platform includes an elongated frame and a sampling gripper as end effector.

FIG. 2 is a top perspective view of the thrusted platform of the aerial system of FIG. 1 in accordance with the first embodiment.

FIG. 3 is a side view of the thrusted platform of FIG. 2, in accordance with the first embodiment.

FIG. 4 is a top view of the thrusted platform of FIG. 2, in accordance with the first embodiment.

FIG. 5 is a top perspective view of a thrusted platform of an aerial system including such a platform, in accordance with a second embodiment in which the thrusted platform includes a bipyramidal shaped frame and a camera as end effector.

FIG. 6 is a side view of the thrusted platform of FIG. 5, in accordance with the second embodiment.

FIG. 7 is a top perspective view of the thrusted platform of FIG. 5, in accordance with the second embodiment, with components thereof removed to better show the positioning of the sets of antagonists thrusters.

### DETAILED DESCRIPTION

In the following description, the same numerical references refer to similar elements. The embodiments, geometrical configurations, materials mentioned and/or dimensions shown in the figures or described in the present description are embodiments only, given solely for exemplification purposes.

Moreover, although the embodiments of the aerial system including the thrusted platform and/or the thrusted platform for same and corresponding parts thereof consist of certain geometrical configurations as explained and illustrated herein, not all of these components and geometries are essential and thus should not be taken in their restrictive sense. It is to be understood, as also apparent to a person skilled in the art, that other suitable components and cooperation thereinbetween, as well as other suitable geometrical configurations, may be used for the aerial system including the thrusted platform and/or the thrusted platform for same, as will be briefly explained herein and as can be easily inferred herefrom by a person skilled in the art. Moreover, it will be appreciated that positional descriptions such as “above”, “below”, “left”, “right” and the like should, unless otherwise indicated, be taken in the context of the figures and should not be considered limiting.

To provide a more concise description, some of the quantitative and qualitative expressions given herein may be qualified with the terms “about” and “substantially”. It is understood that whether the terms “about” and “substantially” are used explicitly or not, every quantity or qualification given herein is meant to refer to an actual given value or qualification, and it is also meant to refer to the approximation to such given value or qualification that would reasonably be inferred based on the ordinary skill in the art or to, including approximations due to the experimental and/or measurement conditions for such given value or estimations provided in the present descriptions for the corresponding value, quantity or qualification.

The terms “a”, “an” and “one” are defined herein to mean “at least one”, that is, these terms do not exclude a plural number of items, unless stated otherwise.

Unless stated otherwise, the terms “connected”, “mounted” and “coupled”, and derivatives and variants thereof, refer herein to any structural or functional connection or coupling, either direct or indirect, between two or more elements. For example, the connection or coupling between the elements can be acoustical, mechanical, optical, electrical, thermal, logical, or any combinations thereof.

It should be noted that, in the context of the current disclosure, the expression “end effector” is used to refer to a component of the thrusted platform configured to interact with the environment in which the thrusted platform is designed to be used or acquire data thereof, to perform the one of the aerial sampling, repair, maintenance, inspection or the like. One skilled in the art will understand that the end effector can be of any type adapted to perform the task for which the platform is designed. For example and without being limitative, in different embodiments of the thrusted platform the end effector can be one of a gripper (e.g. a mechanical gripper (pneumatic, hydraulic, electronic, etc.), a vacuum gripper, a magnetic gripper, etc.), a processing tool (e.g. welding tool, machining tool, painting tool, 3D printing tool, material removal tool, surface finishing tool, sanding tool, grinding tool, etc.), or sensors (2D cameras, 3D cameras, infrared sensors, ultrasonic sensors, laser scanners, etc.). It will be understood that the end effector can be mounted at the end of a robotic arm or could be mounted directly to the structure of the thrusted platform.

In the present description, the expression “based on” is intended to mean “based at least partly on”, that is, this expression can mean “based solely on” or “based partially on”, and so should not be interpreted in a limited manner. More particularly, the expression “based on” could also be understood as meaning “depending on”, “representative of”, “indicative of”, “associated with” or similar expressions.

The term “computing device” is used to encompass computers, servers and/or specialized electronic devices which receive, process and/or transmit data. “Computing devices” are generally part of “systems” and include processing means, such as microcontrollers and/or microprocessors, CPUs or are implemented on FPGAs, as examples only. The processing means are used in combination with storage medium, also referred to as “memory” or “storage means”. Storage medium can store instructions, algorithms, rules and/or data to be processed. Storage medium encompasses volatile or non-volatile/persistent memory, such as registers, cache, RAM, flash memory, ROM, as examples only. The type of memory is, of course, chosen according to the desired use, whether it should retain instructions, or temporarily store, retain or update data.

One skilled in the art will therefore understand that each such computing device typically includes a processor (or multiple processors) that executes program instructions stored in the memory or other non-transitory computer-readable storage medium or device (e.g., solid state storage devices, disk drives, etc.). The various functions, modules, services, units or the like disclosed hereinbelow can be embodied in such program instructions, and/or can be implemented in application-specific circuitry (e.g., ASICs or FPGAs) of the computing devices. Where a computer system includes multiple computing devices, these devices can, but need not, be co-located. In some embodiments, a computer system can be a cloud-based computing system whose processing resources are shared by multiple distinct business entities or other users.

Moreover, the components of the aerial system and/or the thrusted platform described herein can be in data communication through direct communication such as a wired connection or via a wireless connection of a network allowing data communication between computing devices or components of a network capable of receiving or sending data, which includes publicly accessible networks of linked networks, possibly operated by various distinct parties, such as the Internet, private networks (PN), personal area networks (PAN), local area networks (LAN), wide area networks (WAN), cable networks, satellite networks, cellular telephone networks, etc. or combination thereof.

The present description generally relates to aerial systems including a thrusted platform, which are specifically designed to maximize the stability and range of motion of the platform, while allowing the aerial system to be used in locations where proximity of a vertical surface and/or interaction with a vertical surface is required (such as for example and without being limitative to perform sampling of items located on the vertical surface, inspection of infrastructure including vertical surfaces, etc.). The present description also relates to a thrusted platform for such aerial systems. Amongst others, the aerial system and the corresponding platform provide sufficient horizontal range of motion of the thrusted platform to operate in proximity to the vertical surface and maintain a high stability, while the anchoring member (e.g. an unmanned aerial vehicle (UAV) from which the thrusted platform is suspended) can remain safely away from the vertical surface. One skilled in the art will understand that, in the course of the present description, the term “vertical surface” is used to refer to any surface having a section extending upwardly at any angle and should not be restricted to surfaces being strictly or substantially angularly vertical.

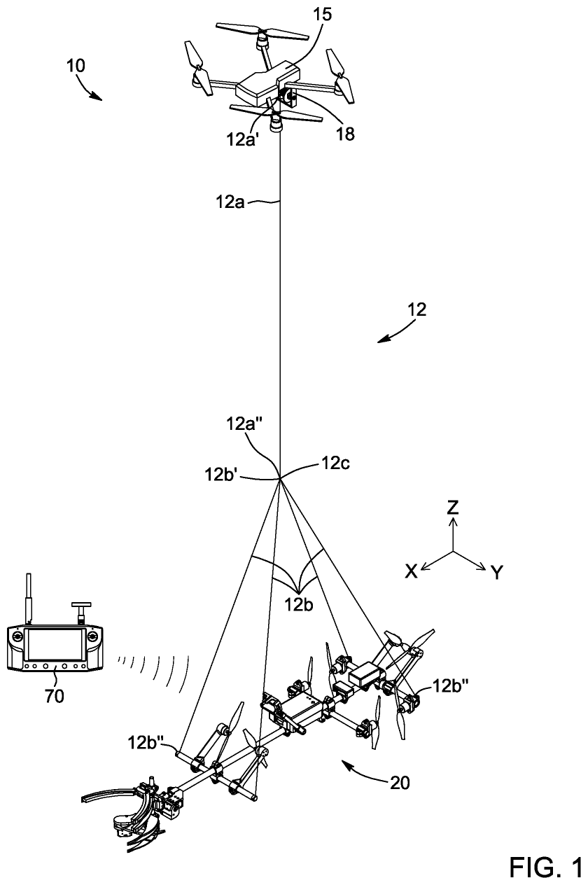

Referring generally to FIG. 1, there is shown an aerial system 10 including a thrusted platform 20 suspended from an anchoring member 15, in accordance with a first embodiment. In the embodiment shown, the anchoring member 15 is a UAV, such that the aerial system 10 includes the cable suspended platform 20 suspended from the UAV, using a support cable 12.

One skilled in the art will understand that in alternative embodiments (not shown), the anchoring member 15 can be different from the UAV of the embodiment shown. The anchoring member 15 can be any aerial vehicle, apparatus, component or structure to which a proximal end 12a of the support line 12 can be anchored, to support the thrusted platform 20 suspended therefrom and operating as a payload. For example and without being limitative, the anchoring member 15 can be a helicopter, a crane, a fixed beam, a natural anchor point, or the like, which offers an anchoring point positioned above the thrusted platform 20 and provides a sufficient payload capacity to support the weight of the thrusted platform 20. As will be better understood in view of the description below, the main function of the anchoring member 15 is to provide vertical support to the thrusted platform 20.

The anchoring member 15 can provide a fixed vertical anchoring point (e.g. when the anchoring member 15 is a fixed structure or the like) or a movable vertical anchoring point (e.g. when the anchoring member 15 is an aerial vehicle, a crane with an anchor movable vertically, or the like) which can be vertically stabilized. The anchoring member 15 can also provide a fixed horizontal anchoring point (e.g. when the anchoring member 15 is a fixed structure or the like) or a movable horizontal anchoring point (e.g. when the anchoring member 15 is an aerial vehicle, a crane with an anchor movable vertically or the like) which can be horizontally stabilized. In an embodiment where a UAV is used as anchoring member 15, it will be understood that different types and models of UAV offering the necessary payload capacity, signal coverage for having the required vertical and horizontal stability, autonomy and/or obstacle collision avoidance system could be used. For example and without being limitative, in an embodiment the UAV can be a DJI M300.

In the embodiment shown in FIG. 1, the support cable 12 includes a first cable section 12a connected to the anchoring member 15 at a proximal end 12a′, a joint 12c connected to the distal end 12a″ of the first cable section 12a and four second cable sections 12b extending between the thrusted platform 20 and the joint 12c. The first cable section 12a extends along the vertical axis Z. The four second cable sections 12b are arranged in a pyramidal configuration and are connected to the joint 12c at the proximal end 12b′ thereof and to a corresponding section of the thrusted platform 20 at the distal end 12b″ thereof. The second cable sections 12b are connected to anchoring points on the thrusted platform 20 horizontally spaced apart from one another along a horizontal plane (a X-Y plane). One skilled in the art will understand that in alternative embodiments (not shown) a different number of second sections cables 12b could be provided (i.e. three second cable sections 12b or more than four second cable sections 12b could be provided).

The length and configuration of the first cable section 12a and second cable section 12b is adapted to the configuration of the thrusted platform 20. Hence, the length and configuration of the first cable section 12a and second cable section 12b allows the thrusted platform 20 to be maintained substantially stable with regard to the horizontal plane (X-Y plane). In other words, the length and configuration of the first cable section 12a and second cable section 12b constrains two degrees of freedom (DOF) corresponding to the rotation around the X and Y axis.

In order to control the vertical positioning of the thrusted platform 20, in an embodiment, the aerial system 10 includes a winch system 18 configured to vary the length of the support cable 12 and control the vertical translation of the thrusted platform 20 platform (i.e. control the translation of the thrusted platform along the vertical axis Z) with respect to the anchoring member 15. In the embodiment shown in FIG. 1, the winch system 18 is mounted below the anchoring member 15 and provides the anchor point for the proximal end 12a′ of the first section of support cable 12a.

In the course of the present description, the term “winch system” is used to refer to any component which can operate to provide one of traction or slack on the support cable and therefore vary the length of the support cable 12. One skilled in the art will understand that, in alternative embodiments, the winch system 18 could be positioned differently than in the embodiment shown in FIG. 1. For example and without being limitative, in an embodiment (not shown) the winch system 18 could be positioned at the distal end 12a″ of the first cable section to provide the joint 12c and perform traction or slack on one of the first section 12a of the second sections 12b of the support cable 12.

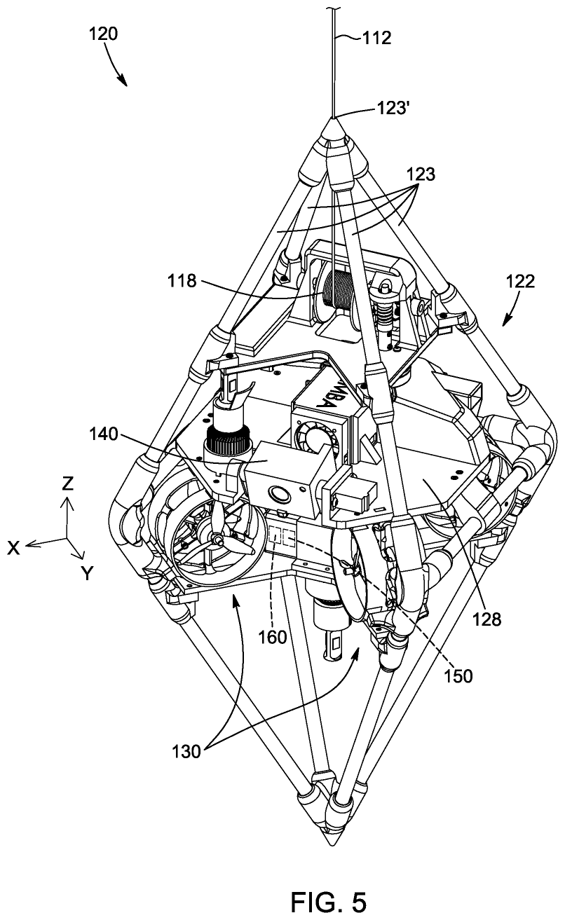

In other alternative embodiments, the winch system 18 could be positioned directly on the thrusted platform 20. For example and without being limitative, in an embodiment (not shown), in the configuration of the thrusted platform shown in FIG. 1, one winch could be provided at each one of the anchoring points on the thrusted platform 20 where the distal end 12b″ of the corresponding second section 12b of support cable is connected to the thrusted platform 20, to provide traction or slack on the corresponding second section of support cable. In another embodiment, at least two winches could be positioned directly on the thrusted platform 20 in the configuration shown in FIG. 1, without having a winch at each one of the anchoring points, each winch being operative to adjust the cable length of a subset of corresponding second sections 12b of support cable. It will be understood that the above-described embodiments would allow independent control of the length of each second sections 12b, or each subset of second sections 12b of the support cable, to control the vertical positioning of the thrusted platform 20 and/or control the horizontal orientation thereof (e.g. to/or to control at least one of the roll and pitch orientation of the thrusted platform and therefore maintain the thrusted platform 20 in a desired horizontal angular orientation). As will be described in more details below, FIG. 5 also shows an embodiment of a thrusted platform 20 with the winch system positioned directly on the thrusted platform 20.

One skilled in the art will understand that the positioning of the winch system 18 on the thrusted platform 20, or the support cable 12, rather than on the anchoring member 15, allows the winch system 18 to be controlled independently, without having to communicate with the anchoring member 15, as will be described in more details below.

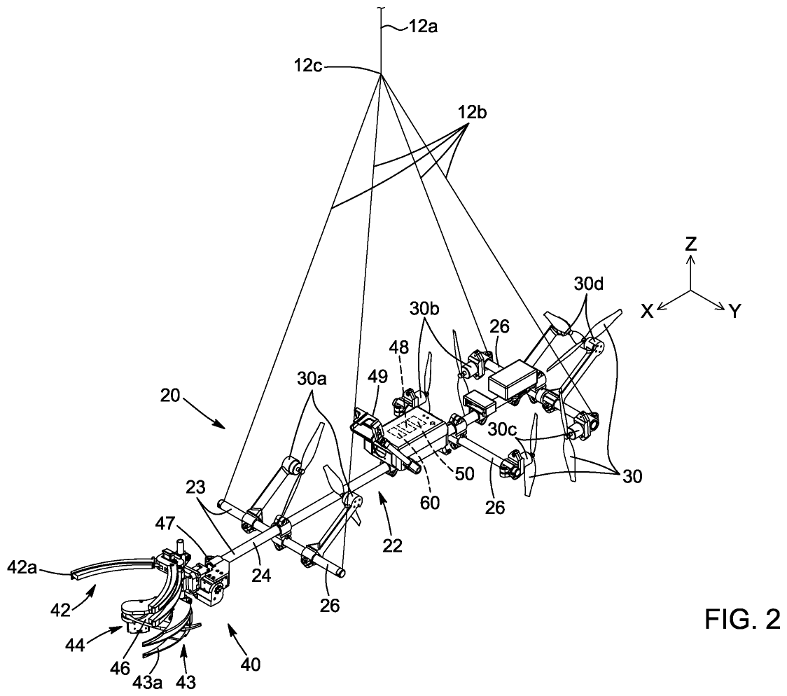

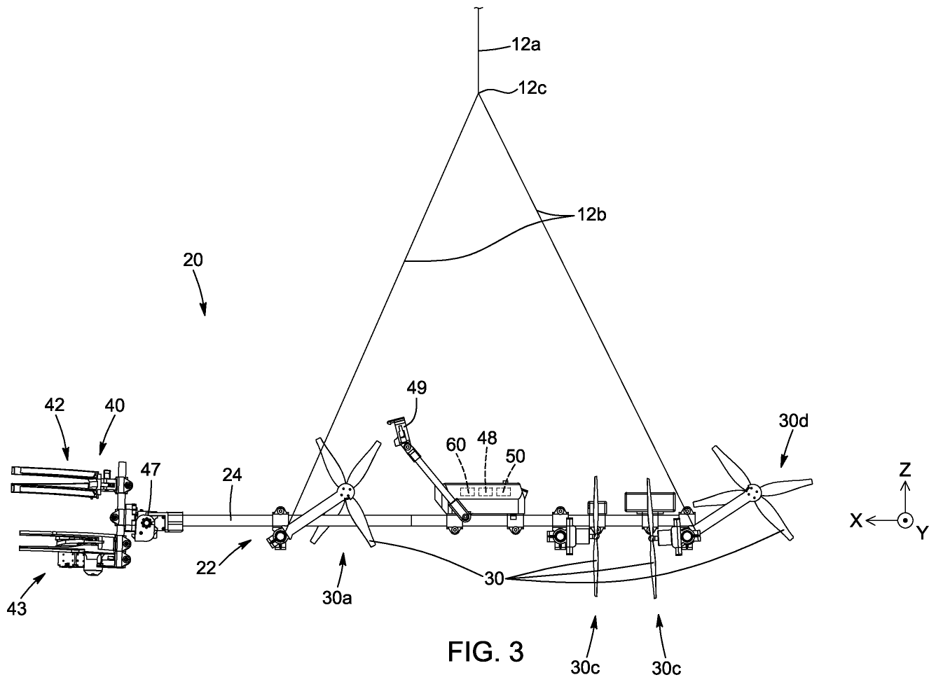

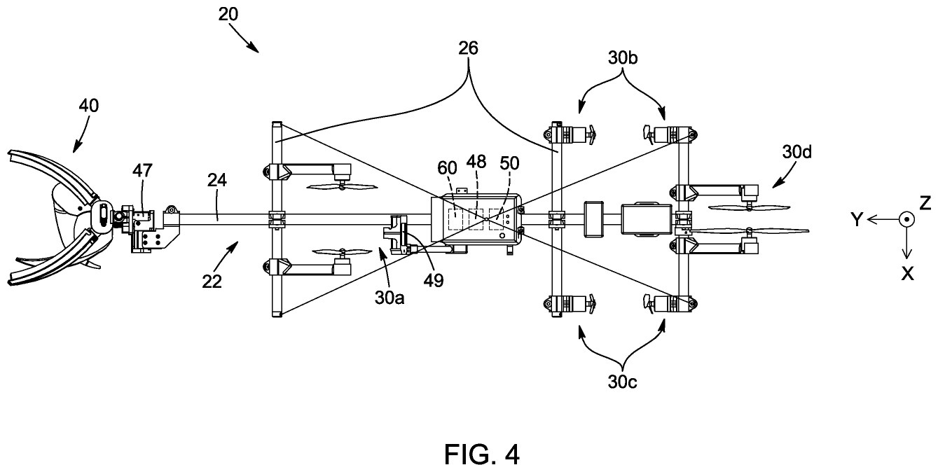

Now referring to FIGS. 2 to 4, the thrusted platform 20 in accordance with the first embodiment will be described in more details below. The thrusted platform 20 includes a frame 22 onto which the components of the platform 20 are mounted. Such components include thrusters 30, an end effector 40, a flight controller 50, and a communication system 60.

In the embodiment shown, the frame 22 includes a central longitudinal shaft 24 extending longitudinally and substantially horizontally along the longitudinal axis X. The frame further includes transversal shafts 26 connected to the central longitudinal shaft 24 and spaced apart from one another along the length of the central longitudinal shaft 24, such that the central longitudinal shaft 24 and the transversal shafts 26 extend substantially along the horizontal plane (the X-Y plane). In the embodiment shown, the transversal shafts 26 extends substantially horizontally along the transversal axis Y. In the embodiment shown, the distal ends 12b″ of the four second cable sections 12b are connected to corresponding sections of the transversal shafts 26, such that they are spaced apart from one another in the horizontal plane (the X-Y plane), with the center of mass of the thrusted platform being therebetween. The frame members 23 including the central longitudinal shaft 24 and transversal shafts 26 are made of rigid lightweight material providing the required stiffness to the frame 22, while minimizing the weight of the thrusted platform 20. For example and without being limitative, in an embodiment the frame members 23 are made of carbon material, but one skilled in the art will understand that other materials offering the necessary rigidity and lightness could be used. One skilled in the art will also understand that, in alternative embodiments (not shown), more than one central longitudinal shaft 24 and/or more or less transversal shafts 26 than the three transversal shafts 26 of the embodiment shown could be used for the frame 22.

The thrusters 30 of the thrusted platform 20 are positioned and configured to perform stabilization of the thrusted platform 20 and/or horizontal displacement thereof, through the control of three DOF of the thrusted platform 20 (i.e. control of the horizontal translation of the platform along the X axis and the Y axis, and the yaw orientation of the platform around the Z axis).

As can be seen in the Figures, the thrusted platform 20 includes a plurality of bidirectional thrusters. In the embodiment shown, the bidirectional thrusters are provided by sets of antagonist thrusters 30a, 30b, 30c, 30d, but one skilled in the art will understand that, in alternative embodiments (not shown), the bidirectional thrusters could be single reversing thruster with symmetric propeller, variable pitch thruster systems, of the like.

As mentioned above, in the embodiment shown, the bidirectional thrusters are embodied using sets of antagonist thrusters, such that the thrusted platform 20 includes a plurality of sets of antagonist thrusters 30a, 30b, 30c, 30d. In the course of the present descriptions, the term “antagonist thrusters” is used to define at least two thrusters 30 each producing a thrust force in an opposed direction to the thrust force of the other thruster. Hence, each set of antagonist thrusters 30a, 30b, 30c, 30d produces a bidirectional force (i.e. a thrust force in a bidirectional direction). One skilled in the art will understand that each set of antagonist thrusters 30a, 30b, 30c, 30d can include two or more thrusters 30 producing thrust forces in opposed directions.

In the embodiment shown, the thrusted platform 20 includes four sets of antagonist thrusters 30a, 30b, 30c, 30d. Advantageously, the four sets of antagonist thrusters 30a, 30b, 30c, 30d are specifically positioned to allow the thrusted platform 20 to be stabilized away from the equilibrium point located directly under the anchor point of the anchoring member 15. Therefore, the four sets of antagonist thrusters 30a, 30b, 30c, 30d can allow the thrusted platform 20 to precisely interact with vertical surfaces, while using an anchoring member 15 positioned safely away from the vertical surfaces.

More specifically, in the embodiment shown, the thrusted platform 20 includes eight thrusters 20 consisting of brushless DC motors and 9″ propellers arranged to form the four sets of antagonist thrusters 30a, 30b, 30c, 30d, each able to produce a bidirectional force of 7 N. This thruster 20 configuration allows the platform 20 to quickly revert the direction of the thrust and thus have better bandwidth than a single reversing thruster with a symmetrical propeller, therefore providing better stabilization of the platform 20. One skilled in the art will however understand that, in alternative embodiments, different thruster types, size and or configuration could be used while still allowing the thrusted platform 20 to be stabilized away from the equilibrium point located directly under the anchor point of the anchoring member 15.

In the embodiment shown, the four sets of antagonist thrusters 30a, 30b, 30c, 30d are positioned and oriented to produce the thrust force in a substantially horizontal direction along a common substantially horizontal plane. In the embodiment shown, the common substantially horizontal plane is the horizontal plane (the X-Y plane). In alternative embodiments (not shown), the four sets of antagonist thrusters 30a, 30b, 30c, 30d could be positioned and oriented to produce the thrust force in a direction deviating of a maximum of 20 degrees from the horizontal plane, along the common substantially horizontal plane (i.e. along a common substantially horizontal plane deviating of a maximum of 20 degrees from the horizontal plane). For ease of reference, in the remaining of the description, the common substantially horizontal plane will be described as the horizontal plane (the X-Y plane). Once again, it should be understood that, in alternative embodiments (not shown), more or less than the four sets of antagonist thrusters 30a, 30b, 30c, 30d could be provided to produce the thrust force in the substantially horizontal direction along the common substantially horizontal plane X-Y, the thrusted platform 20 including at least three sets of antagonist thrusters (or more generally at least three bidirectional thrusters) to provide the required actuation allowing the thrusted platform to move between desired positions while controlling the yaw orientation.

In an embodiment, the thrust force of the four sets of antagonist thrusters 30a, 30b, 30c, 30d allows a translation of the thrusted platform 20 along the horizontal plane (the X-Y plane) and a rotation of the thrusted platform 20 around the vertical axis Z. Hence, the thrust force of at least two of the four sets of antagonist thrusters 30a, 30b, 30c, 30d is produced at an angle from one another (i.e. the thrust force are not parallel to one another) along the horizontal plane (the X-Y plane) and allows a torque around the vertical axis Z, which corresponds to the center of mass of the thrusted platform 20. The torque around the vertical axis Z is provided by at least one thruster being positioned outside of the vertical axis Z (i.e. outside of the center of mass or, in other words, horizontally spaced apart from the vertical axis Z) and producing a thrust force not being aligned with the vertical axis Z (i.e. not being directed towards the vertical axis Z).

In an embodiment, the thrust force of at least two sets of perpendicular antagonist thrusters of the at least two sets of antagonist thrusters are substantially perpendicular along the common substantially horizontal plane X-Y. In other words, the sets of perpendicular antagonist thrusters are positioned and oriented such that at least one set of antagonist thrusters produces a thrust force which is oriented to be substantially perpendicular to the thrust force of at least another set of antagonist thrusters along the common substantially horizontal plane X-Y.

More specifically, in the embodiment shown, the four sets of antagonist thrusters 30a, 30b, 30c, 30d are arranged with two first sets of antagonist thrusters 30b, 30c producing a bidirectional force substantially perpendicular to the bidirectional force of two second sets of thrusters 30a, 30d along the common substantially horizontal plane X-Y. More precisely, in the embodiment shown, the two first sets of thrusters 30b, 30c are oriented to produce a force substantially horizontally along the longitudinal axis X and the two second sets of thrusters 30a, 30d are positioned to produce a force substantially horizontally along the transversal axis Y, substantially perpendicular to the force of the two first sets of antagonist thrusters 30b, 30c. In the embodiment shown, the two first sets of antagonist thrusters 30b, 30c oriented to produce the force substantially horizontally along the longitudinal axis X are positioned between the two second sets of thrusters 30a, 30d positioned to produce the force substantially horizontally along the transversal axis Y. In other words, the two first sets of thrusters 30b, 30c oriented to produce the force substantially horizontally along the longitudinal axis X are positioned centrally with regards to the two second sets of thrusters 30a, 30d positioned to produce the force substantially horizontally along the transversal axis Y, which are positioned outwardly therefrom.

In the embodiment shown, the two first sets of antagonist thrusters 30b, 30c oriented to produce a force substantially horizontally along the longitudinal axis X are provided to help equilibrating the thrust force produced along the longitudinal axis X, as the two first sets of antagonist thrusters 30b, 30c are located on either side of the central longitudinal shaft 24 of the platform 20 and equidistant from the central longitudinal shaft 24. In other words, the two first sets of antagonist thrusters 30b, 30c are positioned on either side of the center of mass of the platform 20 which allows the production of an equilibrated thrust force along the longitudinal axis X. One skilled in the art will understand that, in alternative embodiments (not shown) only one set of antagonist thrusters (or one bidirectional thruster) producing an equilibrated thrust force along the longitudinal axis X could be used.

In the embodiment shown, the two first sets of antagonist thrusters 30b, 30c are mounted to the transversal shafts 26 of the frame 22 and the two second sets of antagonist thrusters 30a, 30d are mounted to extension members extending from corresponding transversal shafts 26 of the frame 22.

In alternative embodiments (not shown), the first sets of antagonist thrusters 30b, 30c and the second sets of antagonist thrusters 30a, 30d could be positioned and oriented to produce a thrust force of a maximum of 20 degrees from a perpendicular orientation, along the common substantially horizontal plane X-Y. Once again, it should be understood that, in alternative embodiments (not shown), the first sets of antagonist thrusters 30b, 30c and/or the second sets of antagonist thrusters 30a, 30d could each include more or less than the two sets of antagonist thrusters of the embodiment shown.

The positioning and orientation of the thrusters 30 allows the thrusted platform 20 to be controlled along at least three DOF by the thrusters 30 (X and Y axis in translation, and orientation around the Z axis) thereby providing increased stability for teleoperated aerial operations in proximity of vertical features. As previously mentioned, the thrusted platform 20 is controllable along a fourth degree of freedom through the control the vertical positioning of the thrusted platform 30 by the winch system 18 (i.e. through control of the translations along the Z axis being performed by the winch system 18), or by vertical translation of the anchoring member 15.

Such a positioning of the thrusters 20 allows to rapidly and efficiently counter disturbances caused by the wind, the horizontal movements of an aerial vehicle operating as anchoring member 15, or the like, to stabilize the platform 20, while allowing a maximized horizontal range of motion of the platform 20.

In the embodiment shown in FIGS. 2 to 4, the thrusted platform 20 is adapted to perform sampling of botanical samples. Hence, in the embodiment shown, the end effector 40 is a sampling system tool configured to perform the collection of the botanical samples. The end effector 40 is positioned to interact with the environment through the positioning of the thrusted platform 20 along the substantially horizontal plane X-Y.

More precisely, in the embodiment shown, the sampling system tool includes an upper gripper 42, a lower gripper 43 and a cutting system 44 cooperating to grab a botanical sample such as, for example and without being limitative a plant, a shrub or the like and cut a section thereof for sampling purposes. The upper gripper 42 and lower gripper 43, each includes fingers 42a, 43a movable to define a space therebetween and to perform a gripping motion for griping an element found in the space. The cutting system 44 includes a rotating saw 46, which can be selectively rotated to perform the cutting of a section of a sample gripped using the upper gripper 42 and/or the lower gripper 43. In an embodiment, a sampling controller 48 including a processor and a memory with instructions stored thereon which when executed by the processor allows the controller 48 to control the movement of the upper gripper 42, the lower gripper and the cutting system 42 and/or to perform a specifically designed sampling sequence including the gripping and the cutting of the sample. For example and without being limitative, in an embodiment, the sampling controller 48 can be operatively connected to a remote control device 70 using the communication system 60 of the thrusted platform 20, which will be described in more details below, for an operator to prompt the sampling controller 48 to move the upper gripper 42, the lower gripper and/or the cutting system 42 in accordance with the sampling sequence, once the thrusted platform 20 has been positioned properly with regard to the botanical sample to be sampled. In the embodiment shown, the sampling system tool is connected to the structure frame 22 by a two DOF actuated joint 47. One skilled in the art will understand that, in alternative embodiments (not shown), no actuated joint could be provided or a connection having greater DOFs could be used.

As mentioned above, one skilled in the art will understand that, in alternative embodiments, the thrusted platform 20 can be adapted to perform different tasks than the above-mentioned aerial sampling of botanical samples. As mentioned above, the thrusted platform 20 can be adapted to perform aerial sampling of elements different from botanical samples, repair, maintenance, inspection, or the like. Hence, the end effector of the thrusted platform 20 can be different from the above-described sampling system tool and be adapted to perform the specific tasks for which the thrusted platform 20 is configured. Similarly to the sampling controller 48, a corresponding end effector controller adapted to the end effector and controlling the operation of the components of the end effector, for operation thereof can also be provided.

In the embodiment shown, the sampling system tool operating as end effector 40 is positioned at a forward end of the longitudinal shaft 24 extending along the longitudinal axis X. The positioning of the two first sets of thrusters 30b, 30c oriented to produce the force substantially horizontally along the longitudinal axis X positioned centrally with regards to the two second sets of thrusters 30a, 30d positioned to produce the force substantially horizontally along the transversal axis Y maximizes the thrust horizontally along the longitudinal axis X, and therefore favours the range of motion of the thrusted platform 20, for the end effector 40 to reach the desired location to perform the interaction.

In an embodiment, the thrusted platform 20 also includes a camera 49 with a field of view showing the sampling system tool operating as end effector 40. The thrusted platform can also include a video transmitter allowing transmission of the images captured by the camera 49 to be displayed to an operator. For example and without being limitative, the video transmitter can allow the images or other data captured by the camera 49 to be communicated to the remote control device 70, using the communication system 60 of the thrusted platform 20, which will be described in more details below, for display of the images captured by the camera 44 on the remote control device 70, thereby providing a first-person view during the sampling process.

The flight controller 50 of the thrusted platform 20 is a component including a control system controlling the direction and magnitude of the thrust force produced by the thrusters 30, in order to automatically control the thrusted platform 20 with regards to its three DOF controllable thereby (i.e. control the horizontal translation of the platform along the X axis and the Y axis, and the yaw orientation of the platform around the Z axis) based on data obtained from a state estimator. In an embodiment, the control system of the flight controller 50 can include three separated proportional-derivative controllers (not shown), each controlling the direction and magnitude of the thrust force produced by the thrusters 30 for a specific DOF, or a multi-variable control systems such as a linear quadratic controller controlling the direction and magnitude of the thrust force produced by the thrusters 30. In an embodiment, the control system can provide multiple modes of assistance (position hold control, attitude hold control, interaction force control, etc.) to simplify the maneuvering of the thrusted platform 20. This implies that, in an embodiment, if the operator does not send any commands, the thrusted platform 20 can be stabilized in its position, thereby allowing the operator to easily maintain the thrusted platform in position (which can be out of its natural equilibrium point) during operation thereof. In an embodiment, the state estimator uses data from a high accuracy Inertial Measurement Unit (IMU) to estimate the position and orientation of the thrusted platform 20 with regard to the anchoring member 15. One skilled in the art will understand that the state estimator could also use an array of sensors such as a distance sensor, a Light Detection and Ranging (LiDAR) scanner, a Global Navigation Satellite System (GNSS) receiver, Optical Sensors, Optical Flow Sensors, RGBD cameras and the like, to provide an absolute position and/or orientation.

The communication system 60 includes one or more interfaces, which allow data communication between the components of the thrusted platform 20 and the remote control device 70 used by an operator to control the movement and/or the operation of the thrusted platform 20.

For example and without being limitative, in an embodiment the remote control device 70 can be a handheld computing device in data communication with the thrusted platform 20 to allow remote control of at least one of the winch system 18, the thrusters 30 (for controlling the direction and magnitude of the thrust forced produced by each one of the thrusters 30), the end effector 40; the camera 49, etc.

For example and without being limitative, in an embodiment, the remote control device 70 and communication system 60 are provided by a Herelink remote controller produced by CubePilot and providing an integrated remote controller, ground station and wireless digital transmission system allowing RC control, HD video and telemetry data to be transmitted between the remote control device 70 and the thrusted platform 20.

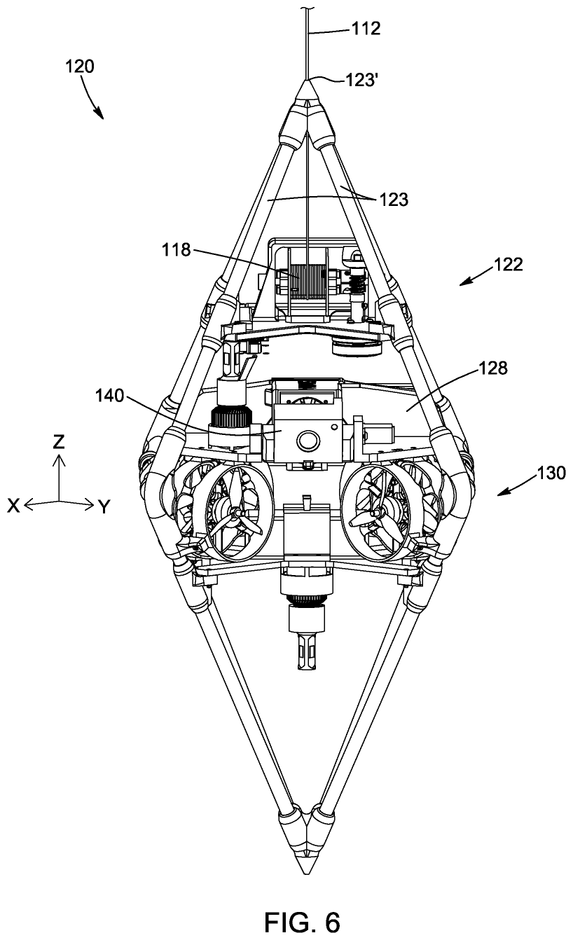

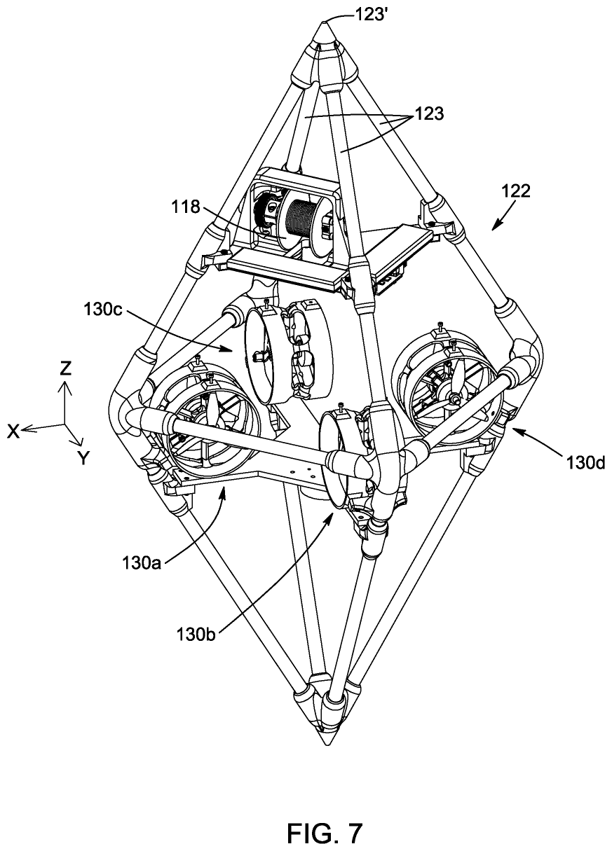

Now referring to FIGS. 5 to 7, there is shown an alternative embodiment of the thrusted platform 120 wherein the features are numbered with reference numerals in the 100 series, which correspond to the reference numerals of the previous embodiment. The thrusted platform 120 has many features similar to the above-described thrusted platform 20. Therefore, for ease of description similar features, components and advantages thereof will not necessarily be repeated herein for this second embodiment but should be considered as being part of this second embodiment.

The thrusted platform 120 is configured to be used as part of an aerial system (not shown) as previously described, where the thrusted platform 120 is suspended from an anchoring member (not shown). As previously mentioned, the anchoring member can be any aerial vehicle, apparatus, component or structure to which the support line 112 can be attached, to support the thrusted platform 120.

In the embodiment of FIGS. 5 to 7, the frame 122 of the thrusted platform 120 includes a plurality of frame members 123 together defining a bipyramidal shaped frame, with the apexes 123′ thereof being positioned at an upper end and a lower end of the frame 122. In the embodiment shown, the common substantially horizontal plane X-Y along which the sets of antagonist thrusters 130a, 130b, 130c, 130d produce the thrust force in the substantially horizontal direction extends substantially along a base of the bipyramidal shaped frame defined in the mirror plane connecting the two pyramids thereof.

In the embodiment shown, the bipyramidal shaped frame defines a square bipyramid with an internal square base lying in the mirror plane that connects the two pyramid halves. However, one skilled in the art will understand that the bipyramidal shaped frame could have any polygonal base lying in the mirror plane that connects the two pyramid halves, therefore defining the corresponding polygonal bipyramid. Moreover, in other alternative embodiments (not shown), the frame members 123 could define a different shape, such as, for example and without being limitative, a pyramidal shape, other polygonal or bipolygonal shape, a spherical shape, or the like. In an embodiment, the shape of the frame is adapted to allow the thrusted platform to be inserted and removed easily from places with multiple obstacles.

In the embodiment shown, a component support 128 is provided inside the frame 122 and is mounted to the frame members 123, with the components of the thrusted platform 120 being mounted to the component support 128. Once again, the frame members 123 are made of material offering the necessary rigidity and lightness, such as, for example and without being limitative, carbon material.

In the embodiment of FIGS. 5 to 7, the support cable 112 includes a single cable section extending along the vertical axis Z, between the anchoring member (not shown) and the thrusted platform 120. As can be seen in the Figures, the support cable 12 extends through the upper apex 123′ of the frame 122 of the thrusted platform 120 and the bipyramidal shape of the frame 122 of the thrusted platform 120 allows the thrusted platform 120 to be maintained substantially stable with regard to the horizontal plane (the X-Y plane).

To control the vertical positioning of the thrusted platform 120, in this alternative embodiment, the winch system 118 is positioned inside the frame 122 of the thrusted platform 120. Once again, the winch system 118 can vary the length of the support cable 112 to move the thrusted platform 120 vertically. As mentioned above, the positioning of the winch system 118 on the thrusted platform 120 allows the winch system 118 to be controlled independently of the anchoring member. It will be understood that, as described above, in alternative embodiments, the winch system 118 could be positioned differently, outside of the frame 122 of the thrusted platform 120 (e.g. directly below the anchoring member).

Once again, the thrusters 130 are positioned and configured to perform stabilization of the platform 120 and/or horizontal displacement thereof, through the control of the three DOF thereof controllable by the thrusters 130 (i.e. control the horizontal translation of the platform along the X axis and the Y axis, and the yaw orientation of the platform around the Z axis).

The thrusted platform 120 again includes four sets of antagonist thrusters 130a, 130b, 130c, 130d, positioned to produce a thrust force substantially horizontally, along a common substantially horizontal plane (the X-Y plane). Once again, in alternative embodiments (not shown), the four sets of antagonist thrusters 130a, 130b, 130c, 130d could be positioned and oriented to produce the thrust force in a direction deviating of a maximum of 20 degrees from the horizontal plane, along the common substantially horizontal plane.

Similarly to the above-described embodiment, the thrust force of the four sets of antagonist thrusters 130a, 130b, 130c, 130d allows a translation of the thrusted platform 120 along the horizontal plane (the X-Y plane) and a rotation of the thrusted platform 120 around the vertical axis Z. Again, the thrust force of at least two of the four sets of antagonist thrusters 130a, 130b, 130c, 130d is produced at an angle from one another (i.e. the thrust force are not parallel to one another) along the horizontal plane (the X-Y plane) and allows a torque around the vertical axis Z, which corresponds to the center of mass of the thrusted platform 120 by having at least one thruster positioned outside of the vertical axis Z (i.e. outside of the center of mass or in other words horizontally spaced apart from the vertical axis Z) and producing a thrust force not being aligned with the vertical axis Z (i.e. not being directed towards the vertical axis Z).

In the embodiment shown, once again the four sets of antagonist thrusters 130a, 130b, 130c, 130d are arranged with two first sets of thrusters 130b, 130c producing a bidirectional force substantially perpendicular to a bidirectional force of the two second sets of thrusters 130a, 130d. Again, the two first sets of thrusters 130b, 130c are positioned and oriented to produce a force substantially horizontally along the longitudinal axis X and the two second sets of thrusters 130a, 130d are positioned and oriented to produce a force substantially horizontally along the transversal axis Y, substantially perpendicular to the force of the two first sets of thrusters 130a, 130d. Once again, the two first sets of thrusters 130b, 130c oriented to produce the force substantially horizontally along the longitudinal axis X are positioned between the two second sets of thrusters 130a, 130d positioned to produce the force substantially horizontally along the transversal axis Y.

Once again, the two first sets of antagonist thrusters 130b, 130c oriented to produce a force substantially horizontally along the longitudinal axis X are provided to allow the production of an equilibrated thrust force along the longitudinal axis X, as the two first sets of antagonist thrusters 130b, 130c are located on either side of the center of mass of the platform 20). One skilled in the art will understand that the same could be said of the two second sets of antagonist thrusters 130a, 130d, regarding the transversal axis Y (i.e. the two second sets of antagonist thrusters 130a, 130d allow the production of an equilibrated thrust force along the transversal axis Y, as they are located on either side of the center of mass of the platform 20).

In the embodiment shown in FIGS. 5 to 7, the thrusted platform 120 is adapted to perform inspection of structures. Hence, in the embodiment shown, the end effector 140 is an inspection camera configured to capture images of the structure, for inspection thereof. Once again it will be understood that the thrusted platform 120 of the present embodiment, could be provided with a different end effector 140 to perform different tasks than the above-mentioned aerial inspection of structures.

Once again, the thrusted platform can include a flight controller 150 and/or a communication system 160 similar to the ones described above, to communicate with a remote control device used by an operator to control the movement and/or the operation of the thrusted platform 120.

Several alternative embodiments and examples have been described and illustrated herein. The embodiments of the invention described above are intended to be exemplary only. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. It is understood that the invention could be embodied in other specific forms without departing from the central characteristics thereof. The present examples and embodiments, therefore, are to be considered in all respects as illustrative and not restrictive, and the invention is not to be limited to the details given herein. Accordingly, while the specific embodiments have been illustrated and described, numerous modifications come to mind. The scope of the invention is therefore intended to be limited solely by the scope of the appended claims.

1. An aerial system comprising:
an anchoring member;
a support cable attached to the anchoring member and suspended therefrom, the support cable extending along a vertical axis;
a thrusted platform suspended from the anchoring member using the support cable, the thrusted platform comprising:
a frame;
at least three bidirectional thrusters each producing a thrust force in a bidirectional direction and allowing the thrusted platform to be controlled thereby along three degrees of freedom, the at least three bidirectional thrusters being positioned and oriented to produce the thrust force in a substantially horizontal direction along a common substantially horizontal plane, with the produced thrust force allowing a translation of the thrusted platform along the common substantially horizontal plane and a rotation of the thrusted platform around the vertical axis;
an end effector mounted to the frame and positioned to interact with the environment or acquire data of the environment, through the positioning of the thrusted platform along the substantially horizontal plane.

2. The aerial system of claim 1, wherein the at least three bidirectional thrusters of the thrusted platform are positioned and oriented to produce the thrust force in a direction deviating of a maximum of 20 degrees from a horizontal plane, along the common substantially horizontal plane.

3. The aerial system of claim 1, wherein the at least three bidirectional thrusters of the thrusted platform are positioned and oriented for the thrust force of at least two perpendicular bidirectional thrusters to be of a maximum of 20 degrees from a perpendicular orientation along the common substantially horizontal plane.

4. The aerial system of claim 3, wherein the at least three bidirectional thrusters of the thrusted platform include at least four bidirectional thrusters, with the at least four perpendicular bidirectional thrusters including at least two first bidirectional thrusters producing a thrust substantially perpendicular along the common substantially horizontal plane to the thrust force of at least two second bidirectional thrusters.

5. The aerial system of claim 4, wherein the at least two first bidirectional thrusters of the thrusted platform are positioned between the at least two second bidirectional thrusters along an axis of the common substantially horizontal plane.

6. The aerial system of claim 1, wherein the frame of the thrusted platform includes a central longitudinal shaft extending substantially horizontally along a longitudinal axis X of the common substantially horizontal plane, with the end effector being positioned at a forward end of the central longitudinal shaft, and wherein the at least two first bidirectional thrusters produce a thrust force substantially along the longitudinal axis X of the common substantially horizontal plane and are positioned on opposed sides of a center of mass of the thrusted platform.

7. The aerial system of claim 6, wherein the frame of the thrusted platform further includes at least two transversal shafts extending substantially horizontally along a transversal axis Y of the common substantially horizontal plane and wherein the support cable includes a first cable section extending along the vertical axis and at least three second cable sections arranged in a pyramidal configuration and each connected at a proximal end to an end of the first cable section and at a distal end to anchoring points on the thrusted platform being horizontally spaced apart from one another along the common substantially horizontal plane and being positioned along one of the central longitudinal shaft and the transversal shafts.

8. The aerial system of claim 1, wherein the frame of the thrusted platform includes a plurality of frame members together defining a bipolygonal shaped frame, with the common substantially horizontal plane along which the at least three bidirectional thrusters produce the thrust force allowing the translation of the thrusted platform along the common substantially horizontal plane and the rotation of the thrusted platform around the vertical axis extending substantially along the base of the bipolygonal shaped frame defined in the mirror plane connecting the two polygons defining the bipolygonal shape.

9. The aerial system of claim 1, wherein each bidirectional thruster includes a set of antagonist thrusters.

10. The aerial system of claim 1, further comprising a winch system operative to vary the length of the support cable and control the vertical positioning of the thrusted platform.

11. A thrusted platform suspendable from an anchoring member using a support cable, the thrusted platform comprising:
a frame;
at least three bidirectional thrusters each producing a thrust force in a bidirectional direction and allowing the thrusted platform to be controlled thereby along three degrees of freedom, the at least three bidirectional thrusters being positioned and oriented to produce the thrust force in a substantially horizontal direction along a common substantially horizontal plane, with the thrust force of at least two of the at least three bidirectional thrusters being produced at an angle from one another along the common substantially horizontal plane and allowing a torque around a vertical axis corresponding to a center of mass of the thrusted platform;
an end effector mounted to the frame and positioned to interact with the environment or acquire data of the environment, through the positioning of the thrusted platform along the substantially horizontal plane.

12. The thrusted platform of claim 11, wherein the at least three bidirectional thrusters are positioned and oriented to produce the thrust force in a direction deviating of a maximum of 20 degrees from a horizontal plane, along the common substantially horizontal plane.

13. The thrusted platform of claim 11, wherein the at least three bidirectional thrusters are positioned and oriented for the thrust force of at least two perpendicular bidirectional thrusters to be of a maximum of 20 degrees from a perpendicular orientation along the common substantially horizontal plane.

14. The thrusted platform of claim 11, wherein the at least three bidirectional thrusters include at least four bidirectional thrusters, with the at least four perpendicular bidirectional thrusters including at least two first bidirectional thrusters producing a thrust substantially perpendicular along the common substantially horizontal plane to the thrust force of at least two second bidirectional thrusters.

15. The thrusted platform of claim 14, wherein the at least two first bidirectional thrusters are positioned between the at least two second bidirectional thrusters, along an axis of the common substantially horizontal plane.

16. The thrusted platform of claim 11, wherein the frame includes a central longitudinal shaft extending substantially horizontally along a longitudinal axis X of the common substantially horizontal plane, with the end effector being positioned at a forward end of the central longitudinal shaft, and wherein the at least two first bidirectional thrusters produce a thrust force substantially along the longitudinal axis X of the common substantially horizontal plane and are positioned on opposed sides of a center of mass of the thrusted platform.

17. The thrusted platform of claim 16, wherein the thrusted platform is suspended from a support cable and the frame of the thrusted platform further includes at least two transversal shafts extending substantially horizontally along a transversal axis Y of the common substantially horizontal plane and wherein the support cable includes a first cable section and at least three second cable sections arranged in a pyramidal configuration and each connected at a proximal end to an end of the first cable section and at a distal end to anchoring points on the thrusted platform being horizontally spaced apart from one another along the common substantially horizontal plane and being positioned along one of the central longitudinal shaft and the transversal shafts.

18. The thrusted platform of claim 11, wherein the frame includes a plurality of frame members together defining a bipolygonal shaped frame, with the common substantially horizontal plane along which the at least three bidirectional thrusters produce the thrust force extending substantially along the base of the bipolygonal shaped frame defined in the mirror plane connecting the two polygons defining the bipolygonal shape.

19. The thrusted platform of claim 11, wherein each bidirectional thruster includes a set of antagonist thrusters.

20. The thrusted platform of claim 11, further comprising a winch system operative to vary the length of the support cable and control the vertical positioning of the thrusted platform.
